(19) United States
(12) Patent Application Publication
(10) Pub. No.: US 2006/0092509 A1
(43) Pub. Date: May 4, 2006

(54) Lenticular lens sheet and manufacturing method thereof

(75) Inventors: Seok-Il Yoon, Daejeon (KR); Young-Il Kah, Suwon-si (KR); Sung-Gi Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/228,338

(22) Filed: Sep. 19, 2005

(30) Foreign Application Priority Data
Nov. 2, 2004 (KR) 2004-88120

(51) Int. Cl. G03B 21/60

(52) U.S. Cl. 359/456

(57) ABSTRACT

A lenticular lens sheet having a wide viewing angle, good uniformity, high resolution, and a manufacturing method thereof. The method for manufacturing the lenticular lens sheet includes the steps of preparing a body of the lenticluar lens sheet having on one side thereof a plurality of incoming-side lenticluar lenses which diffuse incident light from at least one light source, laminating a photoresist layer on the other side of the lenticular lens sheet, exposing a part of the photoresist layer to light, and removing the exposed portion to form an anti-reflection layer having a light transmitting portion and an anti-reflecting portion of external light.

### CROSS-REFERENCE TO RELATED APPLICATIONS

This application claims the benefit under 35 U.S.C. § 119 from Korean Patent Application No. 2004-88120, filed on Nov. 2, 2004, the entire disclosure of which is hereby incorporated by reference.

### BACKGROUND OF THE INVENTION

1. Field of the Invention

The present invention relates to a lenticular lens sheet and a manufacturing method thereof. More particularly, the present invention relates to a lenticular lens sheet having a wide viewing angle, good uniformity, and high resolution, and a manufacturing method thereof.

2. Description of the Related Art

As known in the art, a cathode ray tube (CRT) image projector projects an image from the rear side of the unit and is viewed from the front side. The CRT image projector generally includes three CRT light sources, for example, a green (G) CRT, a blue (B) CRT, and a red (R) CRT so as to project light images to a screen.

FIG. 1A illustrates a screen 100 for use in a conventional CRT image projector.

Referring to FIG. 1A, the screen 100 includes a Fresnel lens sheet 101 for condensing light emitted from a CRT light source (not shown) to focus into parallel rays, a lenticular lens sheet 103 for condensing incident parallel rays from the Fresnel lens sheet 101 to diffuse, for example, in plane XZ, widening horizontal viewing angle, and a protection sheet 105 for protecting the screen.

The lenticular lens sheet 103 comprises a plurality of incoming-side lenticular lenses 103a for condensing and diffusing incident light, a plurality of outgoing-side lenticular lenses 103b reducing a color shift of incident light, an anti-reflection layer 103c for absorbing unnecessary light introduced from an exterior other than a light source to increase image definition, and a lenticular substrate (not shown) on which the lenticular lens is formed.

Hereinafter, a method for forming a conventional anti-reflection layer 103c will be explained with reference to Japanese Patent Laid-Open No. 9-120102, the entire disclosure of which is hereby incorporated by reference. According to this method, an ionizing radiation curing resinous layer is formed at a side where light emits from the lenticular lens, and the ionizing radiation curing resinous layer is exposed to ultraviolet light to cure it and a black ink layer is coated on the cured layer to form a shield layer for preventing a light reflection from external light; however, the prior method has the following two problems.

First, since light emitting from the lenticular lens may be interrupted by the anti-reflection layer, the viewing angle that the viewer can watch may be narrowed, and a white uniformity may be degraded which upon being projected with a white beam, indicates a brightness difference in a percentage (%) between a center portion and an edge portion of the screen.

The phenomenon of light interruption at the anti-reflection layer will now be explained referring to FIG. 1B. FIG. 1B illustrates an optical path through the lenticular lens sheet having the conventional anti-reflection layer.

As shown in FIG. 1B, parallel rays (light ray 1, light ray 2 and light ray 3) emitted through the Fresnel lens are condensed while passing through the incoming-side lenticular lens 103a, and then pass through the outgoing-side lenticular lens 103b. However, since the conventional anti-reflection layer 103c is formed after an inaccurate coating process of black ink, a part of the anti-reflection layer 103c may extend toward a region where the light rays 1, 2 and 3 emit. Thus, light emitted from the outgoing-side lenticular lens 103b, for example, light ray 3b or 1a, passing through a peripheral side of the outgoing-side lenticular lens 103b may strike the extended portion (for example, an edge portion of the anti-reflection layer), thus being interrupted.

Second, it is hard to manufacture a high resolution lenticular lens. High resolution, a preferred characteristic of a screen, is closely related with a thickness of a lenticular lens sheet and a distance (for example, a pitch c) between the lenticular lenses. That is, the smaller the thickness and the shorter the pitch, the higher the resolution may be.

Generally, the thickness of the lenticular lens should be regulated together with the pitch c of the lenticular lens. For example, unless the pitch is reduced, it is more difficult to make the thickness of the lenticular lens thinner. Thus, in order to reduce the thickness of the lenticular lens, there has no choice but to reduce the pitch of the lenticular lens.

As one method to reduce the pitch of the lenticular lens, there is a method for reducing the distance d of the anti-reflection layer covering the outgoing-side lenticular lens.

However, in this case of employing such conventional technology for forming the anti-reflection layer through the coating of the black ink layer, it is difficult to reduce the distance and thickness of the anti-reflection layer.

Accordingly, there is a need for an improved lenticular lens sheet having a wide viewing angle, good uniformity, and high resolution.

### SUMMARY OF THE INVENTION

An aspect of the present invention is to solve at least the above problems and/or disadvantages and to provide at least the advantages described below. Accordingly, an aspect of the present invention is to provide a lenticular lens sheet having a wide viewing angle, a good uniformity and high resolution, and a manufacturing method thereof.

The above object is substantially realized by providing a method for manufacturing a lenticular lens sheet, the method comprising the steps of preparing a body of the lenticluar lens sheet having at one side thereof a plurality of incoming-side lenticluar lenses which diffuse incident light from at least one light source, laminating a photoresist layer on the other side of the lenticular lens sheet, exposing a part of the photoresist layer to light, and removing the exposed portion to form an anti-reflection layer comprising of a light transmitting portion and an anti-reflecting portion of external light.

Preferably, the plural incoming-side lenticular lenses may diffuse incident light in a horizontal direction, the lenticular lens sheet may further include at the other side thereof a plurality of outgoing-side lenticular lenses which reduce a color shift of light emitting from the incoming-side lenticular lens, the photoresist layer may be laminated on the outgoing-side lenticular lens, and in the exposure step, light may be emitted through the incoming-side lenticular lens.

In addition, preferably, in the exposure step, the exposure light may be arranged at the same convergence angle as the light source.

Meanwhile, preferably, the exposure sources comprise a red CRT, a green CRT and a blue CRT.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1A is a schematic view illustrating a construction of a screen 100 for use in a conventional CRT image projector;

FIG. 1B is a schematic view illustrating a conventional optical path through a lenticular lens sheet having an anti-reflection layer;

FIGS. 2A to 2D are exemplary views illustrating manufacturing presses of a lenticular lens sheet according to an embodiment of the present invention; and

FIG. 3 is a flow chart illustrating a manufacturing process of a lenticular lens sheet according to an exemplary embodiment of the present invention.

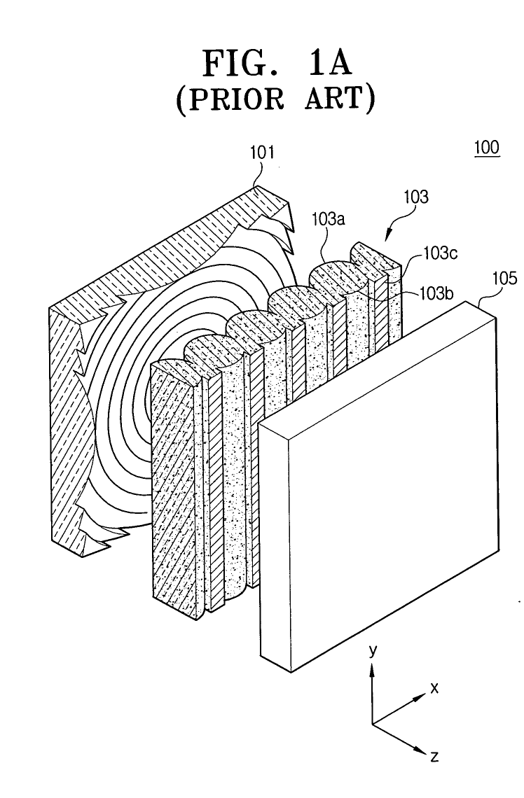

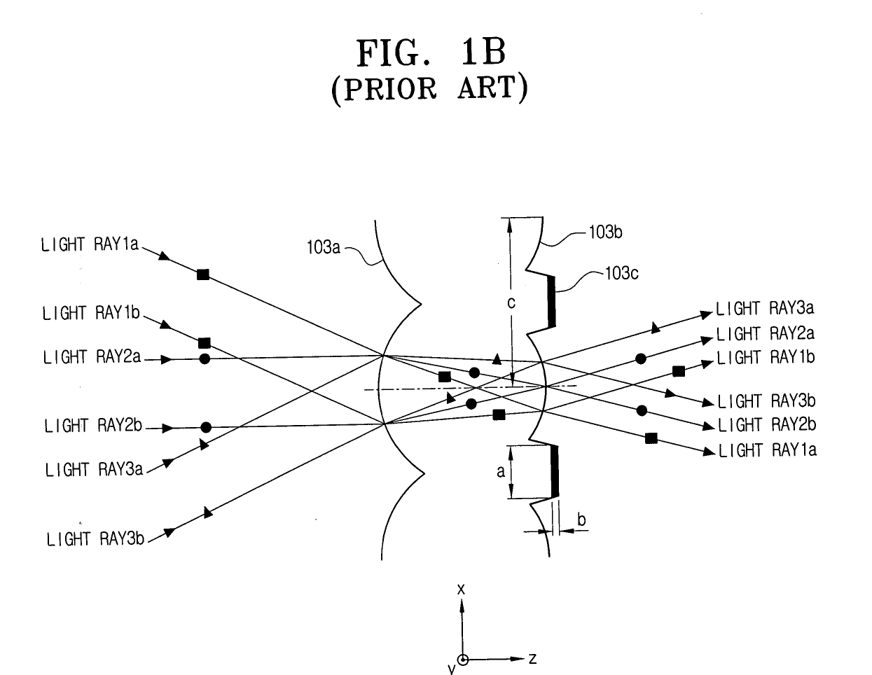

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

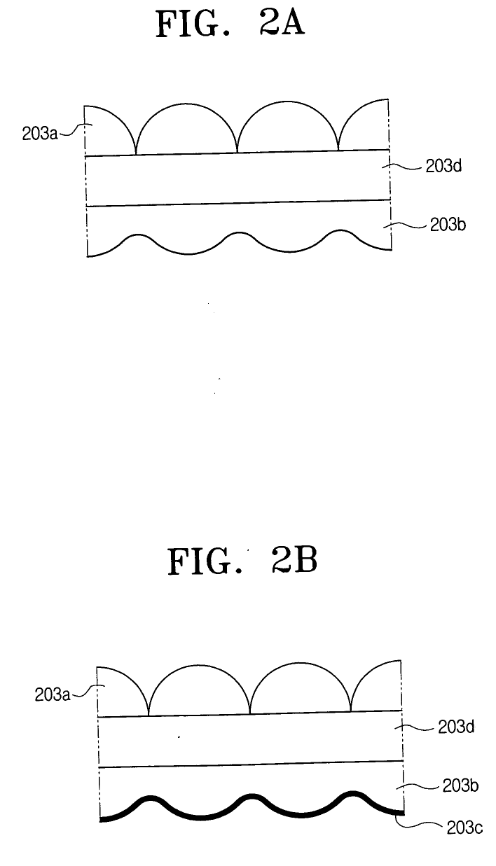

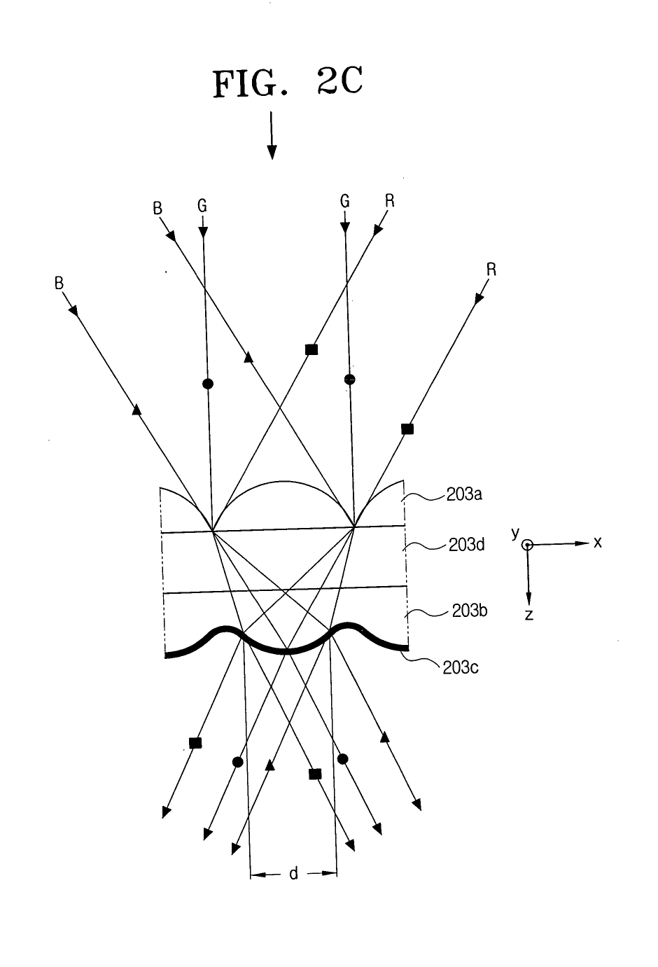

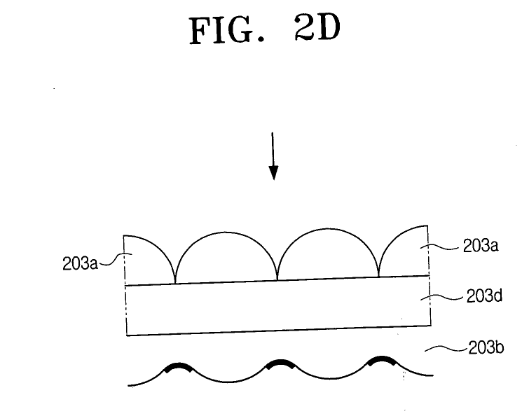

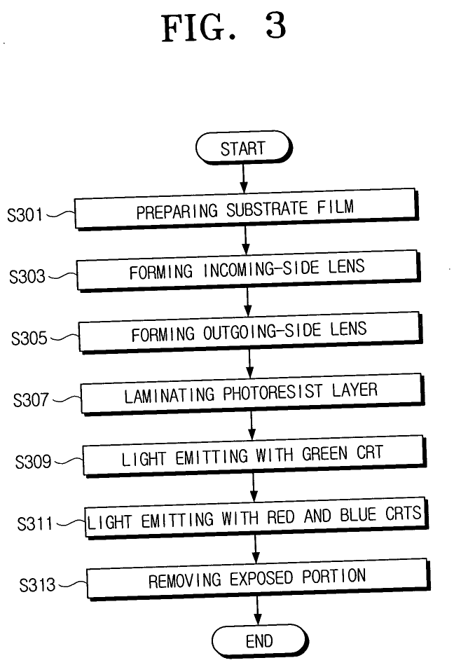

FIGS. 2A to 2D are exemplary views illustrating a manufacturing process of a lenticular lens sheet according to an embodiment of the present invention, and FIG. 3 is a flow chart illustrating a manufacturing process of a lenticular lens sheet. FIGS. 2-3 will now be explained together.

As shown in FIG. 2A, a lenticular lens body is prepared which comprises a plurality of incoming-side lenticular lenses 203a, an outgoing-side lenticular lens 203b and a lenticular substrate 203d.

The lenticular lens body is preferably manufactured by preparing the substrate film (S301), forming the incoming-side lenticular lenses 203a on one side of the lenticular substrate 203d (S303), and forming the outgoing-side lenticular lens 203b on the other side of the lenticular substrate (S305). Such lenticular lens sheets having both incoming and outgoing-sides lenticular lenses 203a and 203b are often called double lenticular lens sheet.

The incoming and outgoing-sides lenticular lenses 203a and 203b may be made from transparent aqueous ultraviolet-curable resin.

The lenticular substrate 203d may be a transparent film (for example, polymethyl methacrylate) easily attachable to the transparent aqueous ultraviolet-curable resin, or any other suitable transparent film surface-treated for easy attachment.

A method for manufacturing a double lenticular lens sheet is disclosed in Korean Publication Patent No. 10-1999-05131 A (filed on Jun. 30, 1997), the entire disclosure of which is hereby incorporated by reference.

FIG. 2B illustrates the lenticular lens sheet in which the photoresist layer 203c is laminated on the outgoing-side lenticular lens 203b.

The photoresist layer 203c is preferably made of photoresist material that upon being exposed to light, a chemical property thereof changes.

The laminating is done by laminating photoresist material on the lenticular lens sheet prepared as in FIG. 2A using a photolithography (S307) process. In this case, a film with good beam penetration such as, for example, PET and PC is attached to the outgoing-side lenticular lens 203b, and the photoresist is then laminated on the film.

FIG. 2C illustrates an exposure process for forming the anti-reflection layer.

In this embodiment, the anti-reflection layer is formed by the exposure of the photoresist layer 203c to ultraviolet. The exposed portion (for example, the region d) of the photoresist layer changes its chemical property so that it will be easily removed (etched), the process of which will be explained later in more detail. For example, the photoresist region exposed to ultraviolet (UV) loses its adhesiveness.

Preferably, UV light is irradiated onto the photoresist layer 203c through the incoming-side lenticular lens 203a.

More preferably, UV is generated simultaneously or successively by plural light sources, for example, a red CRT, a blue CRT and a green CRT. According to one embodiment of the present invention, first, the green CRT emits light onto the photoresist layer 203c (S309) and then the blue CRT and then the red CRT simultaneously emit light onto the photoresist layer 203c (S311).

In case that the red, blue and green CRTs (hereinafter referred to “exposure CRT”) are used for the exposure of the photoresist layer 203c, it may be preferable such that an emission angle of the exposure CRT is substantially the same as the convergence angle of the red, blue and green CRTs used in image projection on screen.

The convergence angle means an angle defined by a center axis of the outgoing-side (or incoming-side) lens and emitting light.

In this manner, the emission angle of the exposure light source is substantially the same as the image projection angle of the light source, so that an anti-reflection layer can be previously removed (S313) if it is positioned on an optical path through which light passes for image projection. Thus, image light passing through the outgoing-side lens is continuously diffused without being interrupted by the anti-reflection layer, providing a wide viewing angle and good uniformity.

In the prior technology, since the anti-reflection layer was formed by the coating of black ink layer on a light outgoing-side of the lenticular lens, there was a technical problem in thickness reduction of the anti-reflection layer. In that case, for example, the distance between pitches of the lenticular lens reaches 520 μm.

However, in exemplary embodiments of the present invention, the anti-reflection layer is formed by light irradiation, so that it can be formed with higher accuracy than the conventional technology. Thus, a fine-pitch lenticular lens can be manufactured. For example, according to an exemplary embodiment of the present invention, the distance between pitches may reach up to 200 μm.

FIG. 2D illustrates a completed lenticular lens sheet after removal of the exposed portion.

As in photolithography, the exposed portion d of the photoresist layer in FIG. 2C is removed (or etched) by etchant, and only unexposed portion remains on the outgoing-side lens portion while being attached.

The removed portion is a portion through which image light will pass, and the unremoved portion is a portion for preventing reflection of external light.

Although the embodiments of FIGS. 2 and 3 employ the double lenticular lens sheet, the exemplary embodiments of the present invention can be of course adapted to other lenticular lens sheet other than the double lenticular lens sheet.

For example, the anti-reflection layer may be conventionally formed by preparing a lenticular lens sheet having on one side only an incoming-side lenticular lens (hereinafter referred to “a single lenticular lens”), laminating a photoresist layer on the other side of the single lenticular lens opposite to the side on which the incoming-side lenticular lens is placed, and exposing a part of the photoresist layer to light and removing the exposed portion.

As described before, the lenticular lens sheet manufactured by the method of an exemplary embodiment of the present invention is provided so that emitting light is not interrupted by the anti-reflection layer to provide a wide viewing angle and good uniformity, and that a pitch of the lenticular lens is reduced to provide high resolution.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for manufacturing a lenticular lens sheet, the method comprising the steps of:
preparing a body of the lenticluar lens sheet having on one side a plurality of incoming-side lenticluar lenses which diffuse incident light from at least one light source;
laminating a photoresist layer on the other side of the lenticular lens sheet;
exposing a part of the photoresist layer to light; and
removing the exposed portion to form an anti-reflection layer comprising a light transmitting portion and an anti-reflecting portion for external light.

2. The method as claimed in claim 1, wherein the plural incoming-side lenticular lenses diffuse incident light in a horizontal direction, the lenticular lens sheet further includes on the other side a plurality of outgoing-side lenticular lenses which reduce a color shift of light emitting from the incoming-side lenticular lens, the photoresist layer is laminated on the outgoing-side lenticular lens, and in the exposure step, light is emitted through the incoming-side lenticular lens.

3. The method as claimed in claim 2, wherein in the exposure step, the exposure light is arranged at substantially the same convergence angle as the light source.

4. The method as claimed in claim 3, wherein the exposure light is composed of a red CRT, a green CRT and a blue CRT.

5. A method for manufacturing a lenticular lens sheet, the method comprising the steps of:
preparing a body of the lenticluar lens sheet having on one side a plurality of incoming-side lenticluar lenses which diffuse incident light from at least one light source;
laminating a photoresist layer on the other side of the lenticular lens sheet;
exposing a part of the photoresist layer to light; and
removing the exposed portion to form an anti-reflection layer.

6. The method as claimed in claim 5, wherein the anti-reflection layer comprises a light transmitting portion and an anti-reflecting portion of external light.

7. The method as claimed in claim 5, wherein the plural incoming-side lenticular lenses diffuse incident light in a horizontal direction, the lenticular lens sheet further includes on the other side a plurality of outgoing-side lenticular lenses which reduce a color shift of light emitting from the incoming-side lenticular lens, the photoresist layer is laminated on the outgoing-side lenticular lens, and in the exposure step, light is emitted through the incoming-side lenticular lens.

8. The method as claimed in claim 7, wherein in the exposure step, the exposure light is arranged at substantially the same convergence angle as the light source.

9. The method as claimed in claim 8, wherein the exposure light is composed of a red CRT, a green CRT and a blue CRT.

10. A lenticular lens sheet, comprising:
a lenticluar lens sheet having on one side a plurality of incoming-side lenticluar lenses which diffuse incident light from at least one light source; and
a photoresist layer including a laminate on the other side of the lenticular lens sheet to expose a part of the photoresist layer to light;
wherein the exposed portion is removed to form an anti-reflection layer comprising a light transmitting portion and an anti-reflecting portion for external light.

11. The lenticular lens sheet as claimed in claim 10, wherein the plural incoming-side lenticular lenses diffuse incident light in a horizontal direction, and
the lenticular lens sheet further includes on the other side a plurality of outgoing-side lenticular lenses which reduce a color shift of light emitting from the incoming-side lenticular lens, and
the photoresist layer is laminated on the outgoing-side lenticular lens;
wherein in the exposure step, light is emitted through the incoming-side lenticular lens.

12. The lenticular lens sheet as claimed in claim 11, wherein in the exposure step, the exposure light is arranged at substantially the same convergence angle as the light source.

13. The lenticular lens sheet as claimed in claim 12, wherein the exposure light is composed of a red CRT, a green CRT and a blue CRT.
